(19) United States
(12) Patent Application Publication
(10) Pub. No.: US 2026/0353033 A1
(43) Pub. Date: Nov. 5, 2026

(54) METHODS AND APPARATUS FOR USING ARTIFICIAL INTELLIGENCE TO PROVIDE REAL-TIME TRAFFIC UPDATES

(71) Applicant: REAL TIME VEHICLE DECISIONS LLC (DBA REAL TIME DECISIONS), Greenville, SC (US)

(72) Inventors: Timothy Barclay Layman, Greenville, SC (US); Earle Eugene Baillie, Greenville, SC (US)

(21) Appl. No.: 19/488,931

(22) PCT Filed: May 31, 2024
(86) PCT No.: PCT/US2024/031954

§ 371 Date: Dec. 1, 2025

Related U.S. Application Data
(60) Provisional application No. 63/505,684, filed on Jun. 1, 2023.
(60) Provisional application No. 63/516,487, filed on Jul. 28, 2023.

(51) Int. Cl. H04W 4/024

(52) U.S. Cl. CPC H04W 4/024

(57) ABSTRACT

An aspect of the invention is a processor configured to continuously retrieve traffic data, filter the traffic data to remove inconsistent data and outliers to generate preprocessed data, convert the preprocessed data into a standardized format based on time and location of data in the preprocessed data, to produce integrated data, store the integrated data into a data storage device, and train one or more machine-learning models using the integrated data as a training set, to produced one or more trained machine-learning models configured to be executed using a request for directions to an end point from a start point from a user for the generation of a data visualization to be presented to the user and that includes predicted traffic conditions, traffic congestion, and travel times, the one or more trained machine-learning models is continuously executed to provide real-time updates to the data visualization.

### CROSS-REFERENCE TO RELATED APPLICATION

This application claim priority to U.S. Provisional Patent Application Ser. Nos. 63/505,684, filed Jun. 1, 2023, and 63/516,487, filed Jul. 28, 2023. The entire content of this application is hereby incorporated by reference herein.

### FIELD OF INVENTION

This present invention relates to radio frequency devices for providing travel directions using artificial intelligence and real-time traffic data.

### BACKGROUND OF THE INVENTION

Low-power cellular chips (e.g., ultra-low-power cellular IoT) can be used in locating or tracking applications. However, such devices are difficult (if not impossible) to initially provision remotely, such as through a cellular signal or BLUETOOTH® IEEE 802.15.1 short-range or near-field communication standards. Provisioning low-power cellular IoT devices remotely is a complex task that requires careful planning and management. Provisioning a low-power cellular IoT devices remotely presents several challenges, especially due to the specific requirements and constraints of such devices. Some challenges include connectivity and network coverage issues (e.g., when IoT devices are often located in remote or challenging environments where network coverage may be sporadic or weak); security concerns (e.g., when provisioning involves transmitting sensitive data such as device identifiers and encryption keys); device constraints; and other issues known in the art.

### SUMMARY OF THE INVENTION

In one or more embodiments, a system includes an Internet of Things (IoT) device comprising a low-power, wide-area network transceiver, and a radio-frequency identification (RFID) transceiver removably coupled to the Internet of Things (IoT) device. The radio-frequency identification (RFID) transceiver is programmed to communicate with a smartphone, receive instructions to provision the Internet of Things (IoT) device, and communicate with the Internet of Things (IoT) device to provision the Internet of Things (IoT) device to access a low-power, wide-area network.

In one or more embodiments, a method of provisioning an IoT device, includes controlling a smartphone to transmit first instructions to an RFID transceiver and controlling the RFID transceiver via the first instructions to transmit second instructions to a low-power, wide-area network transceiver within the IoT device.

In one or more embodiments, an apparatus includes a processor and a memory operatively coupled to the processor. The memory can store instructions to cause the processor to continuously retrieve, from an external data source, traffic data. The instructions can further cause the processor to filter the traffic data to remove inconsistent data and outliers to generate preprocessed data. The instructions can further cause the processor to convert the preprocessed data into a standardized format based on time and location of data in the preprocessed data, to produce integrated data. The instructions can further cause the processor to store the integrated data into a data storage device. The instructions can further cause the processor to train one or more machine-learning models using the integrated data as a training set, to produced one or more trained machine-learning models. The one or more trained machine-learning models can be configured to be executed using a request for directions to an end point from a start point from a user for the generation of a data visualization to be presented to the user and that includes predicted traffic conditions, traffic congestion, and travel times. The one or more trained machine-learning models can be continuously executed to provide real-time updates to the data visualization based on inputs from the user or new data collected from the external data source.

In one or more embodiments, an apparatus includes a processor and a memory operatively coupled to the processor. The memory can store instructions to cause the processor to receive, from a compute device operated by a user, a request for directions to an end point from a start point. The instructions can further cause the processor to execute one or more machine-learning models using the request as an input for the generation of a data visualization that includes traffic predictions. The instructions can further cause the processor to transmit the data visualization to the compute device operated by the user. The instructions can further cause the processor to continuously execute the one or more machine-learning models to provide real-time updates to the data visualization in response to new data collected and stored in a data storage device.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 illustrates a network diagram used in connection with certain exemplary embodiments of the present disclosure.

FIG. 2 illustrates a network diagram of a user in connection with an RFID tracking subsystem and other subsystems, used in connection with certain exemplary embodiments of the present disclosure.

FIGS. 3-4 illustrate various flow diagrams of methods of provisioning, in accordance with certain exemplary embodiments of the present disclosure.

FIG. 5 illustrates an exemplary data flow, in accordance with certain exemplary embodiments of the present disclosure.

FIG. 6 illustrates an exemplary Internet of Things (IoT) device, in accordance with certain exemplary embodiments of the present disclosure.

FIG. 7 illustrates a heads-up display (HUD) IoT device, in accordance with certain exemplary embodiments of the present disclosure.

FIG. 8 illustrates a payment card Internet of Things (IoT) device, in accordance with certain exemplary embodiments of the present disclosure.

FIG. 9 illustrates an exemplary HUD device, useful in explaining certain exemplary embodiments of the present disclosure.

FIG. 10 illustrates a network diagram of a user using a mobile application to retrieve data using artificial intelligence, used in connection with certain exemplary embodiments of the present disclosure.

### DETAILED DESCRIPTION

Radio Frequency Identification (RFID) chips can be used in previously unexplored applications. RFID chips can be ultra-thin, low cost and include integral read/write memory which can be embedded into certain devices or applications. Certain active or passive RFID chips (and/or RFID tags) can be used to build an accurate real-time location system (RTLS).

Certain location systems and processes are described herein. In one embodiment, a system (e.g., a location system) includes an Internet of Things (IoT) device (i.e., a device which can communicate, directly or indirectly, with a network or an internet service). The IoT device can include a low-power, wide-area network transceiver (e.g., a cellular transceiver). The system can also include a radio-frequency identification (RFID) transceiver removably coupled to the IoT device. The RFID transceiver can be programmed to communicate with an electronic device (e.g., a smartphone). The RFID transceiver can be programmed to receive instructions to provision the IoT device. The RFID transceiver can be programmed to communicate with the IoT device to provision the IoT device to access a low-power, wide-area network.

In certain embodiments, RFID transceiver can be removably attached to the IoT device. For example, in one embodiment where the RFID transceiver is removable, the RFID transceiver can be integrated within a label. In such an embodiment, the label can be removably attached to the IoT Device (e.g., a payment card) using a pressure-sensitive adhesive. In certain embodiments, RFID transceiver can be permanently integrated (or semi-permanently integrated) within the IoT Device. For example, in one embodiment where the RFID transceiver is integrated with the IoT Device, the RFID transceiver can be embedded within (e.g., inserted within a slot, contained within a housing, obfuscated from a user, etc.) the IoT Device (e.g., a heads-up display or HUD).

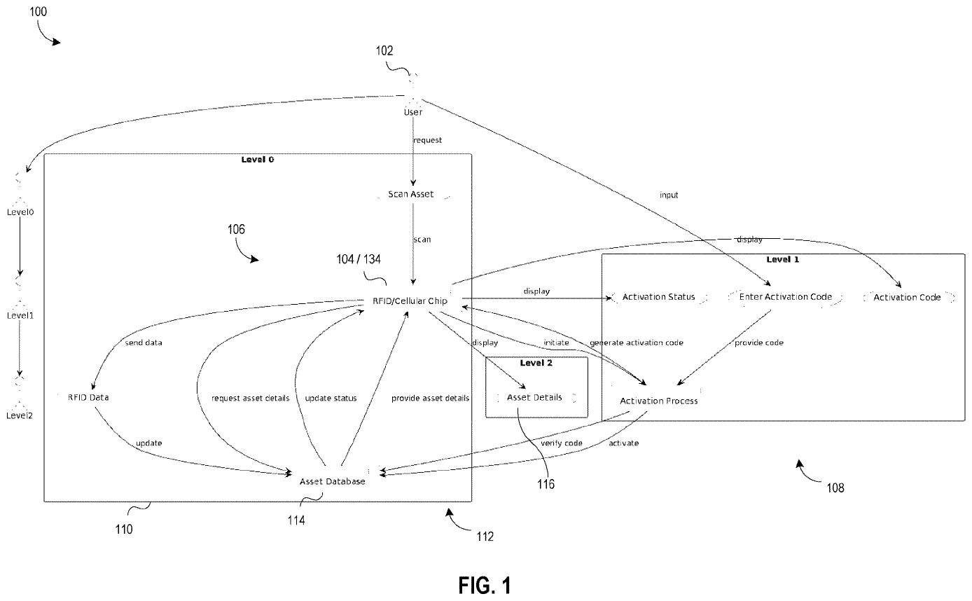

Certain embodiments of the present disclosure are best described in connection with the drawings. Referring now to FIG. 1, a system 100 is illustrated. User 102 can be a user (e.g., an end user, a transitory user, a provider, etc.) of an electronic device (e.g., an IoT device, a smartphone, etc.). As illustrated, user 102 can provide a request to scan an asset (e.g., an object desired to be tracked, such as a package, a vehicle, a valuable asset, etc.). The scan request can be provided to a RFID chip 104 (and/or a cellular chip 134) of transceiver 106 (e.g., an RFID transceiver of asset 110 and/or of IoT device 112). In certain embodiments, transceiver 106 can be a low-power, wide-area network transceiver (e.g., of an IoT device) or a RFID transceiver (removably coupled to the IoT device), or both. Transceiver 106 can generate an activation code to be used in an activation process.

In parallel (e.g., after or substantially simultaneously with the scan request), user 102 can input an activation code (e.g., the same activation code transmitted from transceiver 106) into an electronic device 108 (e.g., a smartphone), thereby initiating an activation process. The activation process can communicate with an asset database 114. Asset database 114 can be in electronic communication with transceiver 106. For example, asset database 114 can communicate with and provide data (e.g., asset details, update status, etc.) to transceiver 106. Asset database 114 can receive certain data (e.g., request for asset details, update data, etc.) from transceiver 106. Transceiver 106 can provide an activation status to electronic device 108. Electronic device 108 can be configured to display the activation status to user 102 (or another user). In one example, the activation status can be displayed via a graphical user interface (GUI) of an application on a smartphone. Transceiver 106 can provide and receive asset details 116.

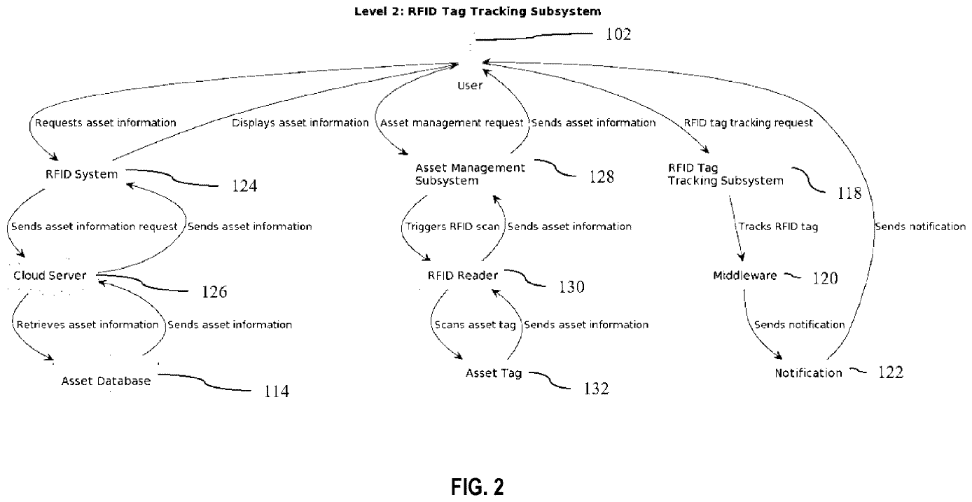

Referring now to FIG. 2, a user 102 interacting with RFID tracking subsystem 118 is illustrated. User 102 is illustrated providing a RFID tag tracking request to RFID tag tracking subsystem 118. RFID tag tracking subsystem 118 tracks an RFID tag and transmits a notification 122 to user 102 via middleware 120. In parallel (i.e., approximately close in time), user 102 can request asset information from RFID system 124 (which may be a part of or include IoT device 112). RFID system 124 can send an asset information request to a server 126 (e.g., a cloud server). Server 126 can retrieve asset information from asset database 114 and provide such information (or related information) to RFID system 124. RFID system 124 can display asset information to user 102. In parallel, user 102 can request information from asset management subsystem 128. Asset management subsystem 128 can trigger an RFID scan to RFID reader 130. RFID reader 130 can scan an asset tag 132, which effectively sends asset information to RFID reader 130. RFID reader 130 can send asset information to asset management subsystem 128. Asset management subsystem 128 can send asset information to user 102.

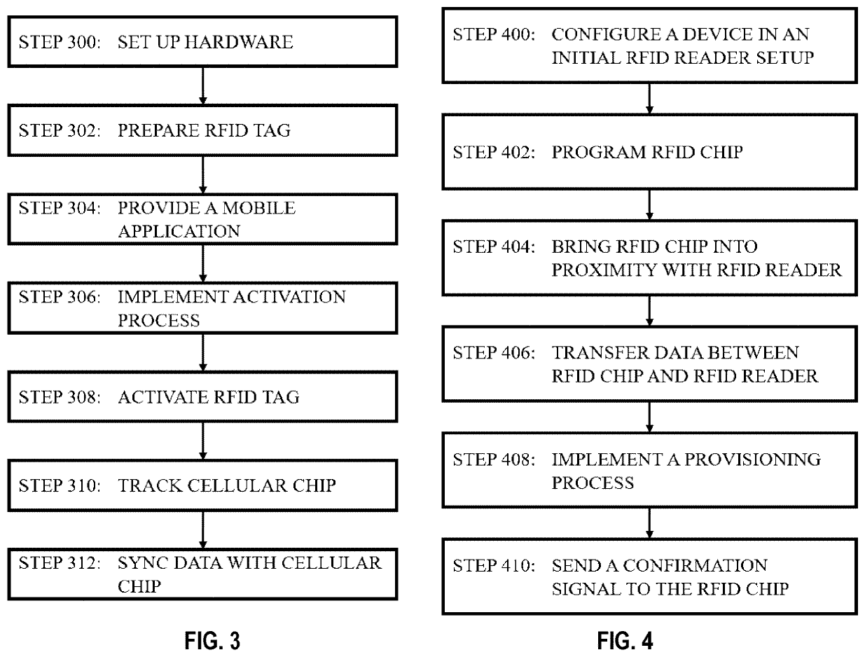

FIGS. 3-4 are flow diagrams useful in illustrating exemplary embodiments of the present disclosure. As is understood by those skilled in the art, certain steps included in the flow diagrams may be omitted; certain additional steps may be added; and the order of the steps may be altered from the order illustrated.

Referring now to FIG. 3, at Step 300, hardware (e.g., an IoT device, an RFID-device, etc.) is set up. At this step, a mobile RFID reader/writer device (with the ability to communicate with RFID tags) is provided. An RFID tag that is compatible with the mobile RFID reader/writer device that supports the required frequency range is also provided. A cellular chip/module capable of connecting to a cellular network for tracking purposes is also provided.

At Step 302, an RFID Tag is prepared. At this step, the RFID tag is attached to an object desired to be tracked (e.g., a package, a vehicle, a valuable asset, etc.). The RFID tag is configured to store the necessary information for activation (e.g., a unique identifier of the cellular chip).

At Step 304, a mobile application is provided. At this step, an application (e.g., a mobile application) that runs on an electronic device (e.g., a smartphone, a tablet, a vehicle-mounted electronic device, a vehicle-integrated electronic device, or another computing device) with the capability to communicate with the RFID reader/writer device is provided (and/or developed). Necessary functionalities are implemented (e.g., permissions are granted, and other software configurations) in the mobile application to initiate the activation process.

At Step 306, an activation process is implemented. At this step, the mobile application is launched on the electronic device (e.g., a smartphone, a tablet, a vehicle-mounted electronic device, a vehicle-integrated electronic device, or another computing device). The mobile RFID reader/writer device is connected (e.g., communicatively) to the electronic device (e.g., a mobile device). The RFID reader/writer device is brought within range of the RFID tag attached to the object desired to be tracked. The application can be used to send a command to the RFID reader/writer device, instructing it to activate the cellular chip (e.g., a cellular IoT chip). Exemplary activation code to activate the cellular IoT chip (written in JavaScript, where the symbol “//” denotes a comment line) is provided below:

```
  function activateRFIDCellularChip(chips) {
    // Get the RFID cellular chips
    const chips = Array.from(chips);
    // Loop through the chips and activate them
    for (const chip of chips) {
      // Get the chip's ID
      const id = chip.id;
      // Create a new request
      const request = new XMLHttpRequest( );
      // Set the request method to POST
      request.method = ″POST″;
      // Set the request URL
      request.url = ″/activate-rfid-cellular-chip″;
      // Set the request body
      request.body = JSON.stringify({
        id: id,
      });
      // Send the request
      request.send( );
      // Check the request status
      if (request.status === 200) {
        // The chip was activated successfully
        console.log(‘RFID cellular chip ${id}
activated successfully‘);
      } else {
        // The chip was not activated successfully
        console.log(‘Error activating RFID cellular
chip ${id}‘);
      }
    }
  }
```

It should be understood that the invention is not limited to the chip activation implemented via this specific script (or code). A person of ordinary skill understands a multitude of alternative activation scripts (in a multitude of alternative programming languages) may be used.

At Step 308, an RFID tag is activated. At this step, the RFID reader/writer device transmits the activation command to the RFID tag (e.g., via radio frequency). The RFID tag receives the activation command and processes said command. Upon successful activation, the RFID tag sends the unique identifier of the cellular chip back to the mobile RFID reader/writer device.

At Step 310, the cellular chip is tracked. At this step, the mobile application receives the unique identifier of the activated cellular chip. The application can use cellular network connectivity to track the location of the object associated with the activated cellular chip. An appropriate cellular tracking service (and/or appropriate APIs) can be used to retrieve location updates and display the tracked information within the mobile application.

At Step 312, data is synced with the cellular chip. Data can include, for example, location data and time data.

In certain embodiments, an RFID chip can serve as an intermediary to provision a device. Such a process is illustrated in FIG. 4.

At Step 400, a device can be configured in an initial RFID reader setup. In this step, a device that needs to be provisioned is equipped with an RFID reader (and/or RFID capabilities integrally built-in to the device are configured for use). The RFID reader is responsible for communicating with the RFID chip.

At Step 402, the RFID chip is programmed. In this step, before the device can be provisioned, an RFID chip can be programmed with relevant information. Such information can include device-specific data (e.g., unique identifiers or configuration settings). Such information can include any necessary provisioning instructions.

At Step 404, the RFID chip is brought into proximity with the RFID reader of the device. In certain embodiments, this can be achieved by placing the RFID chip on a specific area of the RFID reader. In certain embodiments, the RFID chip can be inserted into a dedicated slot. In certain embodiments, the RFID chip is positioned within range (e.g., a radius) of the RFID reader (e.g., a built-in reader).

At Step 406, data is transferred between RFID reader and RFID chip. At this step, once the RFID chip and RFID reader (e.g., of the device) are in close proximity, the RFID reader sends a signal to the RFID chip, thereby “activating” the RFID chip. The RFID chip then transmits the programmed information to the device's provisioning system. In certain embodiments, the transmittal can be done wirelessly (e.g., using radio frequency signals). In certain embodiments, the transmittal can be done through physical electrical contacts (e.g., depending on the specific RFID technology employed).

At Step 408, a provisioning process is implemented. At this step, the device's provisioning system can receive the data transmitted by the RFID chip. The device's provisioning system can interpret the information and execute the necessary provisioning actions. For example, this can involve configuring the device's settings, installing software or firmware updates, activating licenses or subscriptions, linking the device to specific user accounts or networks, and the like.

At Step 410, a confirmation signal is sent to the RFID chip. At this step, after the provisioning process is complete, the device's provisioning system can send a signal (and/or an acknowledgement) to the RFID chip. Such a signal can be used to indicate a successful provisioning, trigger additional actions, provide feedback to a user, and the like.

The process illustrated in FIG. 4 provides certain benefits over existing processes. For example, by using an RFID chip as an intermediary, the provisioning process can be streamlined and automated, reducing the need for manual configuration and potentially enabling mass provisioning of devices in a quick and efficient manner.

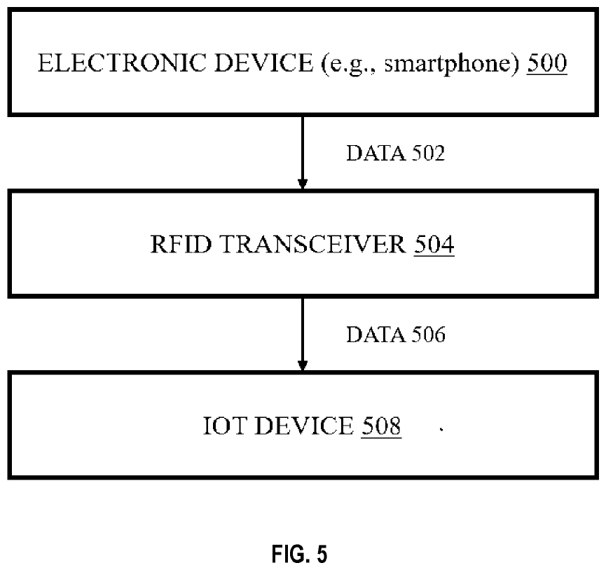

FIG. 5 illustrates an exemplary flow diagram, where an electronic device 500 (e.g., a smartphone) transmits data 502 (e.g., activation data) to an RFID transceiver 504. RFID transceiver 504 then transmits data 506 (e.g., modified activation data, derivative activation data, etc.) to IoT device 508.

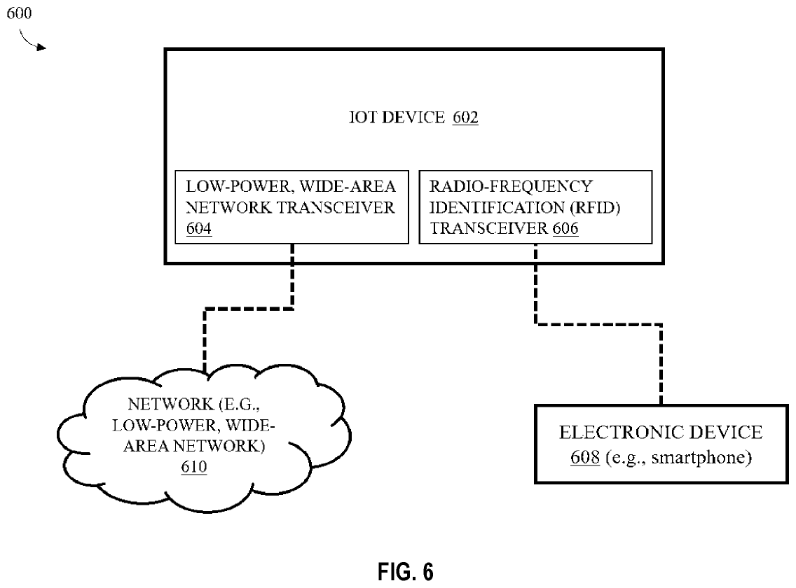

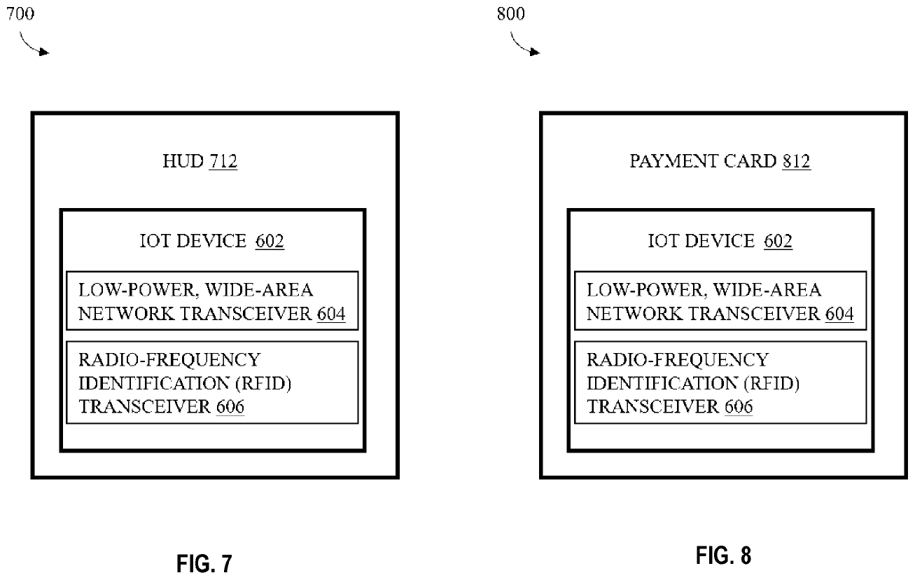

FIG. 6 illustrates a system 600, in accordance with an exemplary embodiment of the present disclosure. System 600 includes IoT device 602. IoT device 602 is illustrated including a low-power, wide-area network transceiver 604. System 600 includes a radio-frequency identification (RFID) transceiver 606, illustrated connected (e.g., removably connected) to IoT device 602. RFID transceiver 606 is programmed to communicate with an electronic device (e.g., a smartphone). RFID transceiver 606 is illustrated communicating with an electronic device 608 (e.g., smartphone). RFID transceiver 606 is programmed to receive instructions to provision IoT device 602. RFID transceiver 606 is programmed to communicate with IoT device 602 to provision IoT device 602 to access a network 610 (e.g., a low-power, wide-area network). FIGS. 7-8 illustrate respectively systems 700 and 800, in accordance with exemplary embodiments of the present disclosure. Systems 700 and 800 are similar in many ways to system 600, where like reference numeral denote like elements. Accordingly, much of the description of system 600 in connection with FIG. 6 is applicable to systems 700 and 800, unless the context indicates otherwise.

FIG. 7 illustrates system 700 including a HUD device 712 (in lieu of IoT device 602 of system 600), in accordance with an exemplary embodiment of the present disclosure. In certain exemplary embodiments, HUD device 712 can be used in a geolocation application. In such an application, HUD device 712 can be provisioned as described in the present disclosure. After being provisioned, a cellular chip within HUD device 712 can transmit and/or receive a signal from one or more cell towers. Alternatively (or in addition to), HUD device 712 can access data from public API's (e.g., related to traffic, weather, emergency data, etc.) in real time. Such transmitting and receiving of data can be used to update a dynamic data structure (e.g., a real time data structure). Such updated data can be overlayed on the display of HUD device 712. In certain embodiments, HUD device 712 can connect to a personal electronic (e.g., a smartphone, a smartwatch, an electronic device, etc.) of a user (e.g., a driver) to transmit and/or receive additional data (e.g., app-data, Google Maps data, Waze data, etc.). Such information can be combined with data received from HUD device 712 (e.g., data from cellular chip) and projected on the display of HUD 712.

FIG. 8 illustrates system 800 including a payment card 812 (in lieu of IoT device 602 of system 600), in accordance with an exemplary embodiment of the present disclosure. In one exemplary embodiment, payment card 812 can be used in a geolocation application. In such an application, payment card 812 can be provisioned as described in the present disclosure. After being provisioned, a cellular chip within the payment card 812 can transmit and/or receive a signal from one or more cell towers. In one geolocation method, payment card 812 can transmit and/or receive a signal from one or more cell towers to “triangulate” the position of payment card 812.

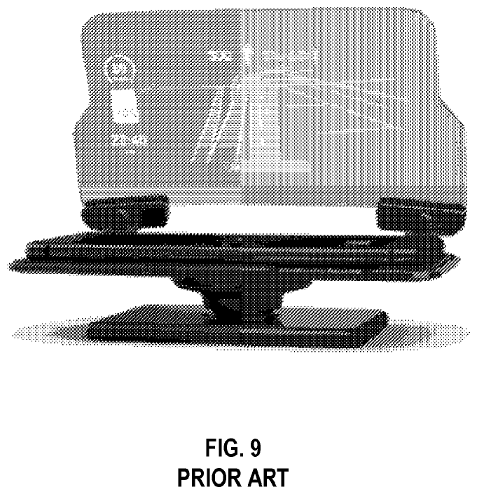

FIG. 9 illustrates an exemplary base HUD device (called “HUDWAY GLASS”, by HUDWAY, SKU: HG-0318-01). Such an exemplary HUD device can be used in connection with certain exemplary embodiments of the present disclosure (e.g., see FIG. 7). For example, an RFID transceiver can be attached (e.g., removably, integrally, etc.) to the exemplary base HUD device, in accordance with certain exemplary embodiments of the present disclosure.

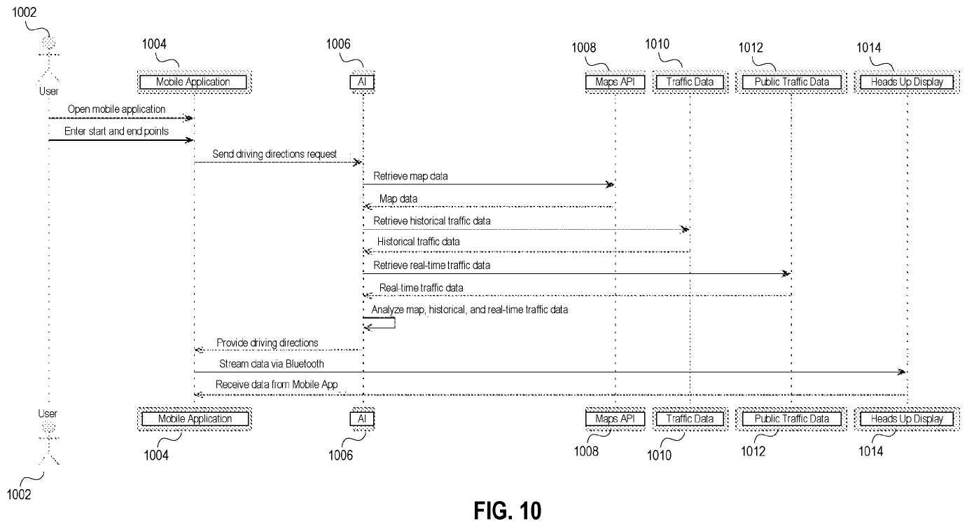

FIG. 10 illustrates a user 1002 requesting information and receiving real-time traffic updates for driving instructions. The user 1002 opens a mobile application 1004 on a compute device (e.g., smartphone, tablet, computer, etc.) and inputs location of the user 1002 and a destination for the user 1002. The mobile application 1004 receives the inputs and transmits a request for driving directions to get from the user's 1002 location to the user's preferred destination to an AI engine 1006 (also referred to as “AI”). The AI 1006 can be or include one or more machine-learning models.

To provide real-time traffic updates, data can be collected from various sources. For example, data can be collected from sensors, such as loop detectors, cameras, and GPS devices, road sensors and/or the like. In some instances, data can be collected from social media, crowd-sourced platforms, and other mobile applications that the user 1002 interacts with on the compute device (e.g., smartphone). In some cases, data can be retrieved from institutions such as transportation agencies, private companies, and crowd-sourced platforms. In some implementations, the data retrieved is preprocessed to clean and/or filter out any noise or inconsistencies. In some cases, preprocessing data can include removing outliers, handling missing data, and/or standardizing formats. Preprocessing also includes converting raw data into a format suitable for analysis by the AI 1006. After preprocessing, the data from different sources is integrated into a unified format. In some implementations, integrating data into a unified format can include aligning the data based on time, location, and other relevant attributes. This is so, at least in part to ensure that the data can be analyzed together to provide accurate traffic updates.

The AI 1006 can be or include at least one of a deep neural network model (DNN), an artificial neural network (ANN) model, supervised machine-learning model, an unsupervised machine-learning model, a fully connected neural network, a convolutional neural network (CNN), a residual network model, a region proposal network (RPN) model, a feature pyramid network (FPN) model, a generative adversarial network (GAN), a K-Nearest Neighbors (KNN) model, a Support Vector Machine (SVM), a decision tree, a random forest, an analysis of variation (ANOVA), boosting, a Naïve Bayes classifier, and/or the like.

In some implementations, the AI 1006 (or one or more machine-learning models) can be trained to analyze the integrated data and extract meaningful insights. Various machine learning algorithms can be applied, such as regression, classification, and clustering, depending on the specific task at hand. For example, regression models can predict travel times based on historical data, while classification models can identify traffic incidents or congestion patterns. For instance, the AI 1006 can include a set of model parameters such as weights, biases, or activation functions that can be executed to annotate and/or classify traffic data. In the training phase, the AI 1006 receives training data and optimizes (or improves) the set of model parameters of the AI 1006. The set of model parameters are optimized (or improved) such that traffic data in the training data can be annotated and/or classified correctly with a certain likelihood of correctness (e.g., a pre-set likelihood of correctness) to analyze and/or predict traffic conditions in the near future (e.g., during transit of the user 1002 once initiated). This involves analyzing historical data and identifying patterns and trends. Predictive models can estimate traffic congestion, travel times, and road conditions, which can be used to inform drivers and provide accurate real-time updates

In some instances, the training data can be divided into batches of data based on a memory size, a memory type, a processor type, and/or the like. In some instances, the requests (e.g., travel destinations) can be divided into batches of data based on a type of the processor (e.g., CPU, GPU, and/or the like) of the compute device the AI 1006 is executed on. In some instances, the training data can be divided into a training set, a test set, and/or a validation set. For example, the training data can be randomly divided so that 60% of the training data is in the training set, 20% of the training data is in the test set, and 20% of the training data is in the validation set. The AI 1006 can be iteratively optimized (or improved) based on the training set while being tested on the test set to avoid overfitting and/or underfitting of the training set. Once the AI 1006 is trained based on the training set and the test set, a performance of the AI 1006 can be further verified based on the validation set.

In some implementations and in response to receiving the request, the AI 1006 is executed and/or caused to retrieve information from external sources such as, for example, a maps API 1008, traffic data 1010, public traffic data 1012, and data from a HID display 1014. In some cases, the HUD display 1014 can be consistent with HUD device of FIG. 7. The AI 1006 can retrieve map data, historical traffic data, and/or real-time traffic data from external sources (e.g., maps API 1008, traffic data 1010, public traffic data 1012, HUD display 1014, etc.). The AI 1006 can also be executed to analyze the retrieved data to provide driving instructions to the user 1002 via the mobile application 1004. Because the execution phase is performed using the set model parameters that were already optimized during the training phase, the execution phase is computationally quick.

In some implementations, data retrieved from external sources can be collected and stored in a database such that the data is processed prior to analysis and/or during analysis such that the mobile application 1004 can generate a user-friendly visualization of the analysis and/or insight provided by the AI 1006. This is so, at least in part for the user 1002 to easily interpret and access real-time traffic information. In some cases, APls or web services can be developed to provide access to the data for integration into third-party applications or navigation systems.

In some implementations, the mobile application 1004 can stream data (e.g., driving directions) via BLUETOOTH® IEEE 802.15.1 short-range protocols. During execution of the driving instructions by the user 1002, the use 1002 can continuously and/or dynamically retrieve data from the mobile application 1004 as the AI 1006 is executed to provide real-time analysis with respect to the user's 1002 travel. For instance, the AI 1006 can process and analyze new data as it arrives by continuously retrieving data from external sources or inputs from the user. For example, a recent accident occurred in the user's 1002 path to the destination, a severe thunderstorm is passing by, the user inputs an intermediary destination, the user chooses to take a detour, etc. To provide real-time traffic updates, the AI 1006 can be implemented with efficient algorithms and systems that can handle large volumes of data in real-time. For example, stream processing technologies like APACHE KAFKA® or APACHE FLINK® can be employed to handle data streams and perform continuous analysis. The AI 1006 can be continuously improved by incorporating feedback and new data. This involves updating the machine learning models with new training data to adapt to changing traffic patterns and improve the accuracy of predictions.

Using AI 1006 in providing real-time traffic updates to the user 1002 via the mobile application 1004 for driving directions affords multiple benefits. For instance, AI 1006 can improve accuracy of driving directions and/or estimated time of arrival by the analysis of data from various sources to provide precise real-time traffic conditions such as, for example, car accidents, weather, construction, temporary road blocks, new roads, and/or the like. By incorporating GPS data, traffic camera footage, local news updates, and/or social media posts, the AI can visualize an accurate situation of current traffic situations for the user 1002.

The AI 1006 can also use historical traffic data to predict future traffic patterns, which can serve to predict traffic congestion during specific hours or days to optimize travel time and/or planning trips. In some cases, by analyzing current and predicted traffic conditions, the AI 1006 can suggest the most efficient routes which can also be dynamically updated as traffic conditions change, ensuring that the user 1002 is on the most optimal path at all times.

In some cases, the AI can also learn from the user's 1002 behavior including, for example, preferred routes, departure times, destinations, average speed on certain roads/highways, and/or the like, to generate a more personalized navigation that caters to the user's 1002 preferences. By effectively directing traffic and suggesting alternative routes, the AI 1006 can play a key role in reducing overall traffic congestion. This effect can lead to smoother, more efficient roads for everyone. The AI 1006 can also alert the user 1002 about road hazards, accidents, and unsafe conditions based on real-time data analysis. These alerts can help the user 1002 avoid dangerous situations and contribute to overall road safety. In some cases, the AI 1006 can also suggest routes that minimize fuel consumption based on traffic conditions, road type, and vehicle characteristics. This feature can also help reduce the environmental impact of driving. For instance, by optimizing routes, predicting and avoiding traffic jams, and offering real-time updates, the AI 1006 can significantly reduce travel times. In some implementations, Al-powered traffic applications can be integrated with other smart systems like smart cities infrastructure or vehicle's in-built Al systems for more efficient and enhanced user experience. The features described above can contribute to saving time for the user 1002 as well as improving cost savings for both individuals and society at large by reducing fuel consumption and avoiding traffic-related accidents.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A system comprising:
an Internet of Things (IoT) device comprising a low-power, wide-area network transceiver; and
a radio-frequency identification (RFID) transceiver removably coupled to the Internet of Things (IoT) device;
wherein the radio-frequency identification (RFID) transceiver is programmed to:
communicate with a smartphone;
receive instructions to provision the Internet of Things (IoT) device; and
communicate with the Internet of Things (IoT) device to provision the Internet of Things (IoT) device to access a low-power, wide-area network.

2. The system of claim 1, wherein the radio-frequency identification (RFID) transceiver is embedded within or on a removable sticker.

3. The system of claim 2, wherein the sticker is configured and adapted to attach to a windshield.

4. The system of claim 3, wherein the windshield is made of a glass.

5. The system of claim 1, wherein the IoT device is a cellular device.

6. The system of claim 1, wherein the system is configured to determine a location of the RFID transceiver.

7. The system of claim 1, wherein the system is configured to determine a location of the RFID transceiver using a cellular network.

8. The system of claim 1, wherein the low-power, wide-area network transceiver implements one or more standards selected from the group consisting of: Long-Term Evolution Machine Type Communication (LTE-M/LTE-MTC), Narrowband Internet of things (NB-IoT), and EC-GSM-IoT.

9. The system of claim 1, wherein the IoT device is configured to activate a subscriber identity module (SIM) card.

10. The system of claim 9, wherein the IoT device is configured to connect to the low-power, wide-area network or another network using the SIM card.

11. The system of claim 9, wherein the IoT device is configurable such that the low-power, wide-area network or another network will recognize the IoT device.

12. The system of claim 1, wherein the system further comprises:
includes a heads-up display (HUD) device, the HUD device including:
a translucent panel; and
a light emitting device configured to reflect light off of the translucent panel,
wherein the IoT transceiver is configured to communicate with the light emitting device;
wherein the RFID transceiver is disposed on or within the HUD device.

13. The system of claim 12, wherein the RFID transceiver can be removably attached to the HUD device.

14. A method of provisioning an IoT device, the method comprising: controlling a smartphone to transmit first instructions to an RFID transceiver; and controlling the RFID transceiver via the first instructions to transmit second instructions to a low-power, wide-area network transceiver within the IoT device.

15. An apparatus comprising:
a processor; and
a memory operatively coupled to the processor, the memory storing instructions to cause the processor to:
continuously retrieve, from an external data source, traffic data;
filter the traffic data to remove inconsistent data and outliers to generate preprocessed data;
convert the preprocessed data into a standardized format based on time and location of data in the preprocessed data, to produce integrated data;
store the integrated data into a data storage device; and
train one or more machine-learning models using the integrated data as a training set, to produced one or more trained machine-learning models,
wherein the one or more trained machine-learning models is configured to be executed using a request for directions to an end point from a start point from a user for the generation of a data visualization to be presented to the user and that includes predicted traffic conditions, traffic congestion, and travel times, the one or more trained machine-learning models is continuously executed to provide real-time updates to the data visualization based on inputs from the user or new data collected from the external data source.

16. The apparatus of claim 15, wherein the data collected from the external data source includes data from sensors, loop detectors, cameras, GPS devices, road sensors, mobile applications, social media, crowd-sourced platforms, or transportation agencies.

17. The apparatus of claim 15, wherein the one or more machine-learning models includes a supervised machine-learning or an unsupervised machine-learning model.

18. An apparatus comprising:
a processor; and
a memory operatively coupled to the processor, the memory storing instructions to cause the processor to:
receive, from a compute device operated by a user, a request for directions to an end point from a start point;
execute one or more machine-learning models using the request as an input for the generation of a data visualization that includes traffic predictions;
transmit the data visualization to the compute device operated by the user; and
continuously execute the one or more machine-learning models to provide real-time updates to the data visualization in response to new data collected and stored in a data storage device.
